(19) United States
(12) Patent Application Publication
(10) Pub. No.: US 2005/0219159 A1
(43) Pub. Date: Oct. 6, 2005

(54) Method of driving display panel

(76) Inventor: Hideto Nakumura, Yamanashi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/083,217

(22) Filed: Mar. 18, 2005

(30) Foreign Application Priority Data
Mar. 22, 2004 (JP) 2004-83108

(51) Int. Cl. G09G 3/28

(52) U.S. Cl. 345/63

(57) ABSTRACT

It is an object to provide a method of driving a display panel capable of displaying high-contrast and high-quality images. In the first sub-field in each field, a selective write addressing is performed for selectively forming a wall charge in each pixel cell in accordance with an input video signal, and in each of sub-fields subsequent to the first sub-field, selective erasure addressing is performed for selectively erasing a wall charge formed in each of the pixel cells in accordance with the input video signal. Further, in the last sub-field in each field, a wall charge is formed by inverting the polarity of a charge formed near each of one electrode of the row electrode pair and the column electrode in each of those pixel cells which have undergone the selective write addressing and selective erasure addressing. Then, the wall charge is erased by inverting the polarity of a charge formed near the other row electrode of the row electrode pair in each of those pixel cells which have undergone the selective write addressing.

### BACKGROUND OF THE INVENTION

1. Field of the Invention

The present invention relates to a method of driving a display panel for displaying images.

2. Description of the Related Art

At present, flat display devices have been commercialized including an AC-type (AC discharge type) plasma display panel. Since each of discharge cells corresponding to each pixel on a plasma display panel emits light utilizing a discharge phenomenon, the discharge cell has only two states, i.e., a lit state corresponding to a maximum luminance level and an unlit state corresponding to a minimum luminance level. Therefore, gradation driving using a sub-field method is conducted in order to generate a halftone display luminance corresponding to an input image signal for the plasma display panel.

In the gradation driving based on the sub-field method, display driving is conducted for one field of image signal in each of a plurality of sub-fields, each of which is assigned a number of times light is emitted. In this event, an addressing stage and sustain stage are executed in sequence. The addressing stage selectively produces a selection discharge in each discharge cell in accordance with an input video signal to form a predetermined amount of wall charge (or erase the wall charge), and the sustain stage repeatedly sustains discharges only in those discharge cells which are formed with the predetermined amount of wall charge to sustain a light emission state associated with the discharge. Further, at least in the first sub-field, an initialization stage is executed prior to the addressing stage for simultaneously reset discharging the respective discharge cells to initialize the amount of wall charges remaining in all discharge cells (form or erase a predetermined amount of wall charge).

However, since the reset discharge simultaneously produced in all the discharge cells does not at all contribute to the contents of an image to be displayed, the light emission associated with this discharge degrades the contrast of the image.

To solve the foregoing problem, Japanese Patent Kokai No. 2001-312244 proposed a driving method which forms a wall charge in each of discharge cells other than discharge cells which are involved in displaying a luminance level 0 (selective write addressing stage), and selectively erases the wall charges from discharge cells in accordance with pixel data in subsequent sub-fields (selective erasure addressing stage). According to this driving method, since the reset discharge for simultaneously initializing all the discharge cells is not required, it is possible to prevent a degradation in contrast due to the influence of the light emission associated with the reset discharge.

However, according to the foregoing driving method, the formation of wall charges varies from one discharge cell to another due to a difference in a total number of sustain discharges produced in each field, and the selective discharge for forming or erasing the wall charge is erroneously produced. This results in a lower quality of display.

### SUMMARY OF THE INVENTION

The present invention has been made for solving the foregoing problem, and it is an object of the invention to provide a method of driving a display panel, which is capable of displaying a high-contrast and high-quality image.

A method of driving a display panel according to one aspect of the present invention is a method of driving a display panel formed with pixel cells associated with pixels at intersections of a plurality of row electrode pairs corresponding to display lines with a plurality of column electrodes arranged across the row electrode pairs for driving the display panel every plural sub-fields which make up each field of an input video signal, wherein a first sub-field in each field includes a selective write addressing stage for performing selective write addressing for selectively forming a wall charge in each of the pixel cells in accordance with the input video signal, and a sustain stage for sustaining light emitted in only those pixel cells formed with the wall charge out of the pixel cells, each of sub-fields subsequent to the first sub-field in each field includes a selective erasure addressing stage for performing selective erasure addressing for selectively erasing the wall charge formed in each of the pixel cells in accordance with the input video signal, and a sustain stage for maintaining light emitted in only pixels formed with the wall charges out of the pixel cells, and a last sub-field in each field includes a wall charge forming stage for forming a wall charge by inverting the polarity of a charge formed near each of one of the row electrode pairs and the column electrodes in each of the pixel cells which have undergone the selective write addressing and the selective erasure addressing in the field, and a wall charge erasing stage for erasing the wall charge by inverting the polarity of a charge formed near the other row electrode of the row electrode pair in each of the pixel cells which have under gone the selective write addressing in the field.

A method of driving a display panel according to a second aspect of the present invention is a method of driving a display panel formed with pixel cells associated with pixels at intersections of a plurality of row electrode pairs corresponding to display lines with a plurality of column electrodes arranged across the row electrode pairs for driving the display panel every plural sub-fields which make up each field of an input video signal, wherein a first sub-field in each field includes a selective write addressing stage for performing a selective write addressing for selectively forming a wall charge in each of the pixel cells in accordance with the input video signal, and a sustain stage for sustaining light emitted in those pixel cells formed with the wall charge out of the pixel cells, each of sub-fields subsequent to the first sub-field in each field includes a selective erasure addressing stage for performing selective erasure addressing for selectively erasing the wall charge formed in each of the pixel cells in accordance with the input video signal, and a sustain stage for maintaining light emitted in only pixels formed with the wall charges out of the pixel cells, and a last sub-field in each field includes a wall charge forming stage for forming a wall charge by inverting the polarity of a charge formed near each of one of the row electrode pairs and the column electrode in each of the pixel cells which have undergone the selective write addressing and the selective erasure addressing in the field, a wall charge polarity inverting stage for inverting the polarity of a charge formed near each of the row electrodes of the row electrode pair in the pixel cells which have undergone the selective write addressing in the field, and a wall charge erasing stage for erasing the wall charge by inverting the polarity of a charge formed near the other row electrode of the row electrode pair in each of the pixel cells which have under gone the selective write addressing in the field.

### BRIEF DESCRIPTION OF THE DRAWINGS

FIG. 1 is a diagram generally showing the configuration of a plasma display device which drives a plasma display panel to display a halftone image based on a driving method according to the present invention;

FIG. 2 is a diagram showing an exemplary light emission driving sequence for driving a PDP 10 shown in FIG. 1 based on the sub-field method;

FIG. 3 is a diagram showing pixel driving data GD generated by a pixel driving data generator circuit 2 and a light emission pattern in one field (frame) when the plasma display panel is driven in accordance with the light emission driving sequence shown in FIG. 2;

FIG. 4 is a diagram showing timings at which each of an address data driver 4, a first sustain driver 5, and a second sustain driver 6 applies a variety of driving pulses to column electrodes and row electrodes of the PDP 10 in accordance with the light emission driving sequence shown in FIG. 2;

FIGS. 5A-5C are diagrams showing a change in the formation of a wall charge in each pixel cell in a wall charge adjusting stage Ec in FIG. 4 during a display corresponding to a minimum luminance level (black display);

FIGS. 6A-6C are diagrams showing a change in the formation of the wall charge in each pixel cell in the wall charge adjusting stage Ec in FIG. 4 during a display corresponding to a maximum luminance level;

FIGS. 7A-7C are diagrams showing a change in the formation of the wall charge in each pixel cell in the wall charge adjusting stage Ec during a display corresponding to an intermediate luminance level;

FIG. 8 is a diagram showing other exemplary timings at which a variety of driving pulses are applied to the column electrodes and row electrodes of the PDP 10;

FIGS. 9A-9C are diagrams showing a change in the formation of the wall charge in each pixel cell in the wall charge adjusting stage Ec in FIG. 8 during a display corresponding to the minimum luminance level (black display);

FIGS. 10A-10C are diagrams showing a change in the formation of the wall charge in each pixel cell in the wall charge adjusting stage Ec in FIG. 8 during a display corresponding to the maximum luminance level;

FIGS. 11A-11C are diagrams showing a change in the formation of the wall charge in each pixel cell in the wall charge adjusting stage Ec in FIG. 8 during a display corresponding to an intermediate luminance level;

FIG. 12 is a diagram showing another example of the wall charge adjusting stage Ec shown in FIG. 8;

FIG. 13 is a diagram showing the operation in a wall charge adjusting stage EEc which is substituted for the wall charge adjusting stage Ec upon power-on or at a frequency of once per M fields (M is an integer equal to or larger than two) when the display panel is driven in accordance with the sequence shown in FIG. 4; and

FIG. 14 is a diagram showing the operation in the wall charge adjusting stage EEc which is substituted for the wall charge adjusting stage Ec upon power-on or at a frequency of once per M fields (M is an integer equal to or larger than two) when the display panel is driven in accordance with the sequence shown in FIG. 8.

### DETAILED DESCRIPTION OF THE INVENTION

In the first sub-field of each field, selective write addressing is performed for selectively forming a wall charge in each of pixel cells in accordance with an input video signal, whereas in each of sub-fields subsequent to the first sub-field, selective erasure addressing is performed for selectively erasing the wall charge formed in each of the pixel cells in accordance with the input video signal. Further in the last sub-field of each field, a wall charge is formed by inverting the polarity of the charge formed near each of one row electrode of a row electrode pair and a column electrode within those pixel cells in which the selective write addressing and selective erasure addressing were performed in that field. Then, the wall charge is erased by inverting the polarity of the charge formed near the other row electrode of the row electrode pair in the pixel cell for which the selective write addressing was executed.

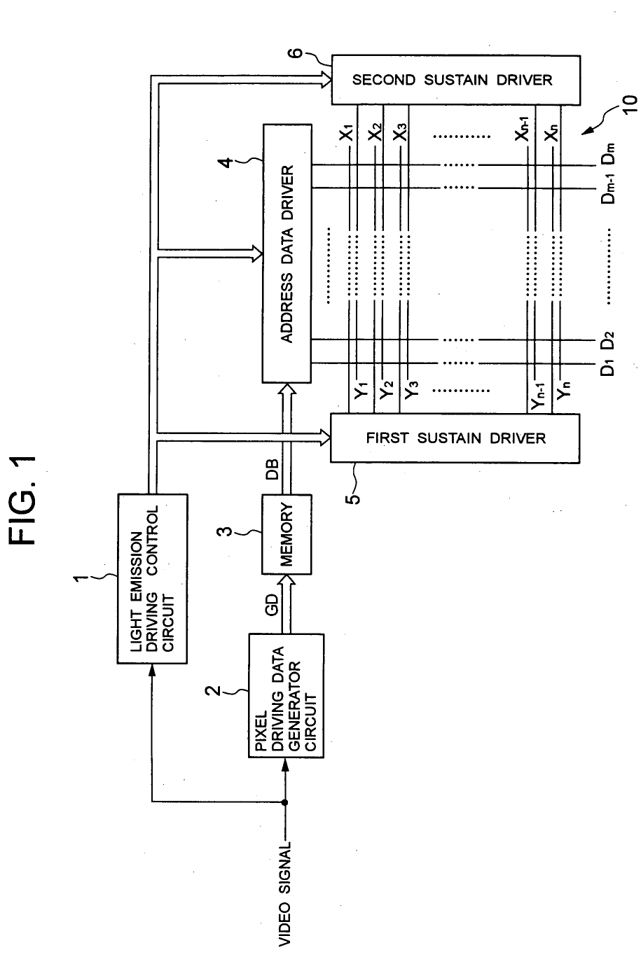

FIG. 1 is a diagram generally showing the configuration of a plasma display device which drives a plasma display panel to display a halftone image based on a driving method according to the present invention.

As shown in FIG. 1, the plasma display device comprises a light emission driving control circuit 1, a pixel driving data generator circuit 2, a memory 3, a address data driver 4, a first sustain driver 5, a second sustain driver 6, and a PDP 10.

The PDP 10, which is a plasma display panel, comprises a front transparent substrate (not shown) formed with n row electrodes X₁-Xₙ and row electrodes Y₁ -Yₙ alternately arranged thereon; and a back substrate (not shown) formed with address electrodes which are m column electrodes D₁-Dₘ. In the PDP 10, a pair of row electrodes (X, Y) adjacent to each other comprises one display line of the PDP 10. In other words, the row electrodes X₁-Xₙ and row electrodes Y₁ -Yₙ form a fist display line to an n-th display line on the PDP 10. A discharge space, which is formed between the front transparent substrate and the back transparent substrate, is filled with a discharge gas. A pixel cell associated with a pixel is formed at each intersection of each row electrode pair and column electrode including the discharge space. In other words, the PDP 100 is formed with the pixel cells associated with pixels in a matrix of n rows and m columns.

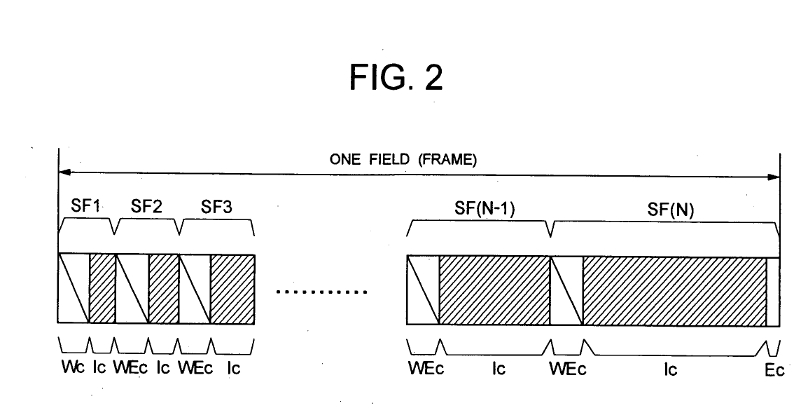

The light emission driving control circuit 1 controls each of the address data driver 4, first sustain driver 5, and second sustain driver 6 in accordance with an input video signal to drive the PDP 10 to emit light in accordance with a light emission driving sequence which employs a sub-field method, for example, as shown in FIG. 2.

In the light emission driving sequence shown in FIG. 2, in each of sub-fields SF1-SF(N), a sustain stage Ic is executed, where a number of light emissions (light emission period) corresponding to the sub-field is assigned. In this event, in the first sub-field SF1, a selective write addressing stage Wc is executed prior to the sustain stage Ic. In each of the subsequent sub-fields SF2-SF(N), a selective erasure addressing stage WEc is executed prior to the sustain stage Ic. Further, only in the final sub-field SF(N), a wall charge adjusting stage Ec is executed immediately after the sustain stage Ic. Detailed operations of these sustain stage Ic, selective write addressing stage Wc, selective erase addressing stage WEc, and wall charge adjusting stage Ec will be described later.

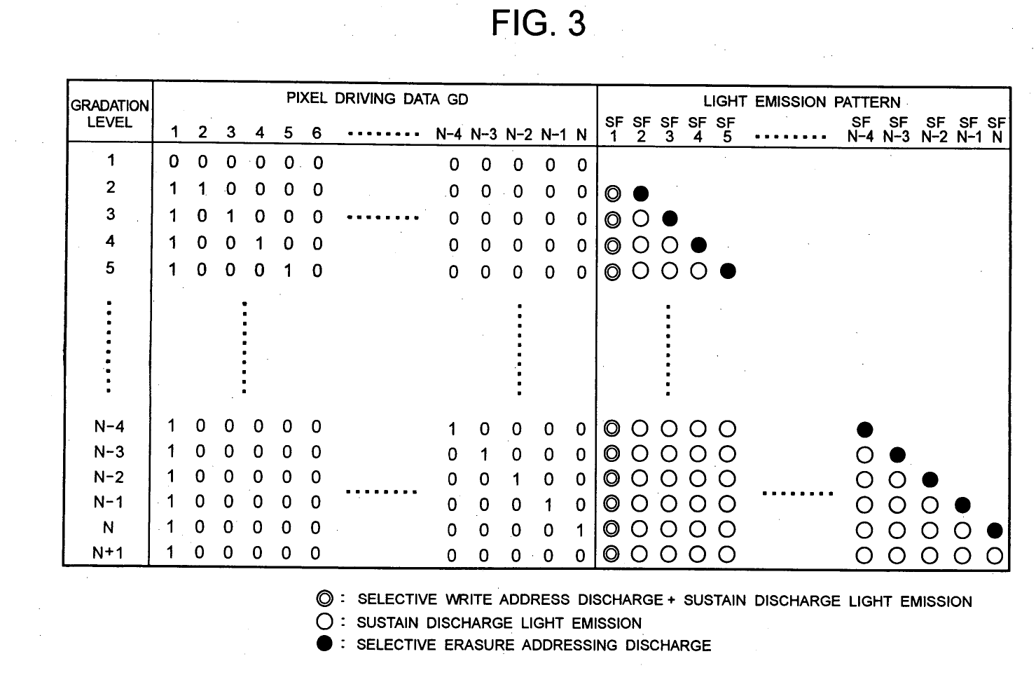

The pixel driving data generator circuit 2 generates N-bit pixel driving data GD corresponding to each pixel in accordance with a luminance level of the pixel indicated by an input video signal, and supplies the pixel driving data GD to the memory 3. For example, the pixel driving data generator circuit 2 selects one corresponding to a luminance level indicated by the input video signal from (N+1) pixel driving data GD as shown in FIG. 3, and supplies the selected pixel driving data GD to the memory 3.

The memory 3 sequentially writes the pixel driving data GD. Here, the memory 3 performs a read operation as follows after having written the pixel driving data GD for one screen, i.e., each of the (nxm) pixel driving data GD corresponding to each of the pixel cells on the first row, first column to the n-th row, n-th column. In this event, in the memory 3, each pixel driving data GD corresponding to each pixel cell in one screen is divided into every bit digits (first to N-th bits) which are regarded as pixel driving data bits DV1-DB(N). The memory 3 first sequentially reads each of pixel driving data bits DB1 corresponding to each pixel cell for every display line upon execution of the selective write addressing stage Wc for the sub-field SF1 as shown in FIG. 2. Next, the memory 3 sequentially reads each of pixel driving data bits DB2 corresponding to each pixel cell for every display line upon execution of the selective erasure addressing stage WEc for the sub-field SF2, and supplies the address data driver 4 with the read pixel driving data bits DB2. Similarly, the memory 3 sequentially reads pixel driving data bits DB2, DB3, DB4, DB5, . . . , DB(N) corresponding to each pixel cell for every one display line upon execution of each selective erasure addressing stage WEc for the sub-fields SF3, SF4, SF5, . . . , SF(N), and supplies the address data driver 4 with the read pixel driving data bits.

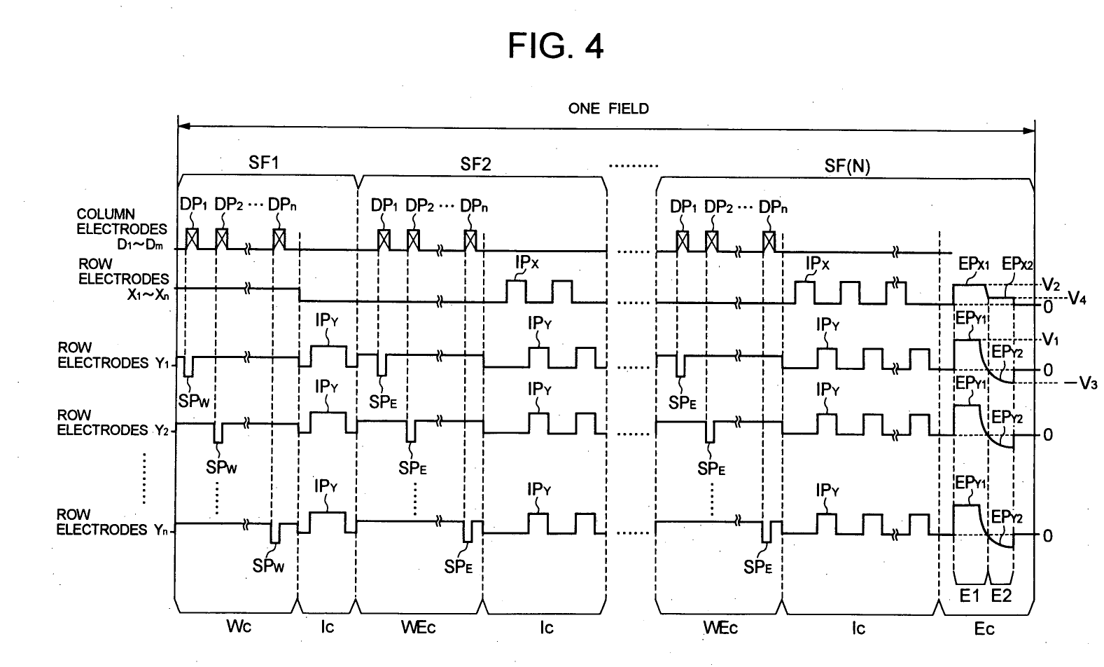

The address data driver 4, first sustain driver 5, and second sustain driver 6 generate a variety of driving pulses as shown in FIG. 4 in accordance with the light emission driving sequence shown in FIG. 2, and apply the driving pulses to the column electrodes D₁-Dₘ and row electrodes X₁- Xₙ, Y₁-Yₙ of the PDP 10.

In FIG. 3, first, in the selective write addressing stage Wc of the first sub-field SF1, the address data driver 4 generates a pixel data pulse which has a pulse voltage in accordance with a logical level of the pixel driving data bit DB₁ (bit at the first bit digit of the pixel driving data GD shown in FIG. 3) read from the memory 3. For example, the address data driver 4 generates a pixel data pulse which is at a high voltage when the pixel driving data bit DB1 is at logical level 1, and at a low voltage when the pixel driving data bit DB1 is at logical level 0. Then, the address data driver 4 groups the pixel data pulses for every display line (m) to generate pixel data pulse groups DP₁-DPₙ which are sequentially applied to the column electrodes D₁-Dₘ, as shown in FIG. 4. Further, in the selective write addressing stage Wc, the second sustain driver 6 generates a write scan pulse SP_{W} of negative polarity, as shown in FIG. 4, at the same timing at which each of the pixel data pulses DP₁-DPₙ is applied, and sequentially applies the write scan pulse SP_{W} to the row electrodes Y₁-Yₙ. In this event, a discharge is produced only in a pixel cell at an intersection of a display line which has been applied with the write scan pulse SP_{W} with a “column” which has been applied with the pixel data pulse at high voltage (hereinafter called the “selective write addressing discharge”), and charged particles are generated in the discharge space of the pixel cell. Then, after the end of the selective write address discharge, a predetermined amount of wall charge is formed in the pixel cell which is set to a “lit mode.” On the other hand, the selective write address discharge as described above is not produced in a pixel cell which is applied with the write scanning pulse SP_{W} but with the pixel data pulse at low voltage. Therefore, the wall charge as described above is not formed in this pixel cell which is set to an “unlit mode.”

In the sustain stage Ic of the sub-field SF1, the second driver 6 simultaneously applies a sustain pulse IP_{Y} of positive polarity, as shown in FIG. 4, to each of the row electrodes Y₁-Yₙ. In this event, a sustain discharge is produced only in the pixel cells which have been set to the “lit mode” of all pixel cells of the PDP 10.

Next, in the selective erasure addressing stage WEc of the sub-field SF2, the address data driver 4 generates a pixel data pulse which has a pulse voltage in accordance with a logical level of the pixel driving data bit DB2 (bit at the second digit of the pixel driving data GD shown in FIG. 3) read from the memory 3. For example, the address data driver 4 generates a pixel data pulse which is at a high voltage when the pixel driving data bit DB2 is at logical level 1 and at a low voltage (zero volt) when the pixel driving data bit DB2 is at logical level 0. Then, the address data driver 4 groups the pixel data pulses for every display line (m) to generate pixel data pulse groups DP₁-DPₙ which are sequentially applied to the column electrodes D₁-Dₘ of the PDP 10, as shown in FIG. 4. Further, in the selective erasure addressing stage WEc, the second sustain driver 6 generates an erasure scan pulse SP_{E} of negative polarity, as shown in FIG. 4, at the same timing at which each of the pixel data pulses DP₁-DPₙ is applied, and sequentially supplies the erasure scan pulse SP_{E} to the row electrodes Y₁-Yₙ. In this event, a discharge is produced only in a pixel cell at an intersection of a display line applied with the erasure scan pulse SP_{E} with a “column” applied with the pixel data pulse at high voltage (hereinafter called the “selective erasure addressing discharge”) to erase the wall charge which has remained within the discharge space of the pixel cell. With the selective erasure addressing discharge, this pixel cell is set to the “unlit mode.” On the other hand, the selective erasure address discharge is not produced as described above in a pixel cell which is applied with the erasure scan pulse SP_{E} but with the pixel data pulse at low voltage. Therefore, this pixel cell maintains the same state as before. In other words, a pixel cell in which the wall charge remains maintains the “lit mode,” while a pixel cell in which the wall charge does not remain maintains the “unlit mode.”

In a sustain stage Ic of the sub-field SF2, the first sustain driver 5 and second sustain driver 6 alternately apply the sustain pulses IP_{X}, IP_{Y}, as shown in FIG. 4, to the row electrodes X₁-Xₙ, Y₁-Yₙ, repeatedly a number of times corresponding to the weighting of the sub-field SF2. In this event, only those pixel cells set in the “lit mode” of all the pixel cells of the PDP 10 sustain discharge each time they are applied with the sustain pulse IP_{X} or IP_{Y} to maintain a light emission state associated with the discharge.

In each of the sub-fields SF2-SF(N) after the sub-field SF2, the selective erasure addressing stage WEc and sustain stage Ic are sequentially executed in a manner similar to the sub-field SF2.

Here, the wall charge adjusting stage Ec in the last sub-field SF(N) consists of a wall charge forming stage E1 and a wall charge erasing stage E2.

In the wall charge forming stage E1, the second sustain driver 6 simultaneously applies the row electrodes Y₁-Yₙ with a wall charge forming pulse EP_{Y1} having a pulse voltage V₁ of positive polarity, as shown in FIG. 4. Further, in the wall charge forming stage E1, the first sustain driver 5 simultaneously applies the row electrodes X₁-Xₙ with a wall charge forming pulse EP_{X1}having a pulse voltage V₂ of positive polarity, as shown in FIG. 4, at the same timing at which the wall charge forming pulse EP_{Y1} is applied. The pulse voltage V₁ of the wall charge forming pulse EP_{Y1} is larger than the pulse voltage V₂ of the wall charge forming pulse EP_{X1}. Also, as shown in FIG. 4, a change in voltage of the wall charger forming pulse EP_{Y1} in a falling edge is slower than a change in voltage of the wall charge forming pulse EP_{X1}in a rising edge.

In the wall charge erasing stage E2, in turn, the second sustain driver 6 simultaneously applies the row electrodes Y₁-Yₙ with a wall charge erasing pulse EP_{Y2} having a pulse voltage V₃ of positive polarity which slowly changes in voltage in a rising edge, as shown in FIG. 4. Further, in the wall charge erasing stage E2, the first sustain driver 5 simultaneously applies the row electrodes X₁-Xₙ with a wall charge erasing pulse EP_{X2} having a pulse voltage V₄ of positive polarity, as shown in FIG. 4, at the same timing as the wall charge erasing pulse EP_{Y2} is applied. The pulse voltage V₃ of the wall charge erasure pulse EP_{X2} is smaller than the pulse voltage V₂ of the wall charge forming pulse EP_{X1}.

The following description will be made on the operation associated with the wall charge adjusting stage Ec separately for a display performed corresponding to the minimum luminance level, for a display performed corresponding to the maximum luminance level, and for a display performed corresponding to the intermediate luminance level.

(1) Display Performed Corresponding to Minimum Luminance Level (Black Display)

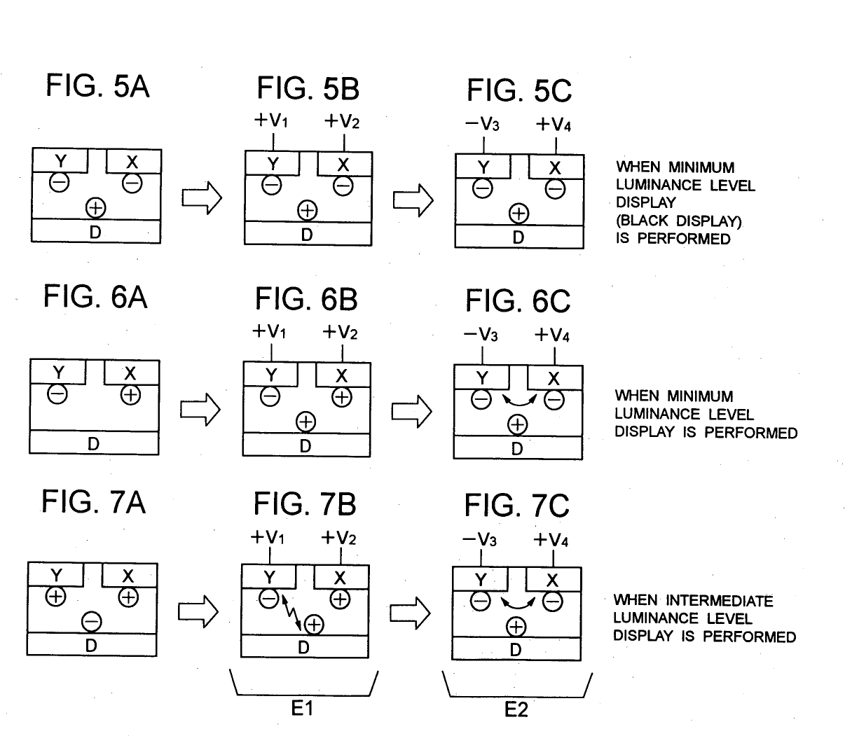

In this event, the pixel driving data generator circuit 2 generates the pixel driving data GD which has the first to N-th bits all set to logical level 0, corresponding to the first gradation level, as shown in FIG. 3. This results in a so-called black display state in which no discharge is produced in any of the selective write addressing stage Wc and sustain stage Ic of the sub-field SF1, and the selection erasure addressing stage WEc and sustain stage Ic of each of the sub-fields SF2-SF(N). In this event, the formation of the wall charge in the pixel cell immediately before the wall charge adjusting stage Ec is as shown in FIG. 5A. Specifically, a positive charge is formed on the column electrode; a negative charge on the row electrode X; and a negative charge on the roe electrode Y. Here, in the wall charge forming stage E1, the pulse voltage V₁ of positive polarity and the pulse voltage V₂ of positive polarity are applied to the row electrode X, respectively, but any of the voltage between the row electrodes Y, Y, a voltage between the row electrode X and the column electrode D, and a voltage between the electrode Y and the column electrode D does not reach a discharge start voltage, thus failing to produce a discharge. Therefore, as shown in FIG. 5B, the formation of a charge in each pixel cell upon execution of the wall charge forming stage E1 remains the same as that shown in FIG. 5A. In the next wall charge erasing stage E2, a negative pulse voltage V₃ is applied to the row electrode Y, and a positive pulse voltage V4 is applied to the row electrode X, respectively. However, even at this time, any of the voltage between the row electrodes X, Y, the voltage between the row electrode X and the column electrode D, and the voltage between the row electrode Y and the column electrode D does not reach the discharge start voltage, so that no discharge is produced. Therefore, as shown in FIG. 5C, the formation of a charge within each pixel cell upon execution of the wall charge erasing stage E2 is the same as those shown in FIGS. 5(a) and 5(b). In other words, a so-called charge neutral state (hereinafter, this state is called the “wall charge extinction state”) is present, where charges of the same polarity (negative polarity) remain on both the row electrodes X, Y.

(2) Display Performed Corresponding to Maximum Luminance Level

In this event, the pixel driving data generator circuit 2 generates the pixel driving data GD corresponding to the (N+1)th gradation level as shown in FIG. 3. The pixel driving data GD corresponding to the (N+1)th gradation level has the first bit set at logical level 1, and the second to N-th bits all set at logical level 0. Therefore, as indicated by double circles in FIG. 3, a selective write addressing discharge and a sustain discharge are produced in the selective write addressing stage Wc and sustain stage Ic, respectively, of the sub-field SF1. Further, as indicated by white circles in FIG. 3, the sustain discharge is produced in the sustain stage Ic of each of the sub-fields SF2-SF(N), resulting in a display state at a so-called maximum luminance level. In this event, the formation of a charge in the pixel cell immediately before the wall charge adjusting stage Ec is as shown in FIG. 6A due to the influence of the sustain discharge produced in response to the last sustain pulse IP_{Y} in the sustain stage Ic of he sub-field SF(N). Specifically, a positive charge is formed on the column electrode D; a positive charge on the row electrode X, and a negative charge on the row electrode Y. Here, in the wall charge forming stage E1, the pulse voltage V₁ of positive polarity is applied to the row electrode Y, and the pulse voltage V₂ of positive polarity is applied to the row electrode X, respectively, but any of the voltage between the row electrodes X, Y, the voltage between the row electrode X and the column electrode D, and the voltage between the row electrode Y and the column electrode D does not reach the discharge start voltage, so that no discharge is produced. Therefore, as shown in FIG. 6B, the formation of a charge in each pixel cell upon execution of the wall charge forming stage E1 remains the same as that shown in FIG. 5A. Then, in the next wall charge discharge stage E2, as the pulse voltage V₃ of negative polarity is applied to the row electrode Y, and the pulse voltage V₄ of positive polarity is applied to the row electrode X, respectively, a faint erasure discharge is produced between the row electrodes X, Y due to the formation of a positive charge on the row electrode X and a negative charge on the row electrode Y. After the end of the erasure discharge, the formation of a charge in the pixel cell is as shown in FIG. 6C, where a positive charge is formed on the column electrode D; a negative charge on the row electrode X, and a negative charge on the row electrode Y. In other words, the charges of the same polarity (negative polarity) remain on both the row electrodes X, Y, resulting in a so-called wall charge erased state.

(3) Display Performed Corresponding to Intermediate Luminance Level

In this event, the pixel driving data generator circuit 2 generates one of the pixel driving data GD corresponding to the second gradation level to the N-th gradation level, respectively, shown in FIG. 3 in accordance with a luminance level indicated by an input video signal. Specifically, the pixel driving data generator circuit 2 generates the N-bit pixel driving data GD which has the first bit set at logical level 1 without fail, only one of the second to N-th bits set at logical level 1, and all the remaining bit digits set at logical level 0. Therefore, as shown in FIG. 3, a selective write addressing discharge and a sustain discharge (indicated by a double circle) are produced in the sub-field SF1, and subsequently a sustain discharge (indicated by a white circle) is produced in each sub-field until a selective erasure addressing discharge (indicated by a black circle) is produced in a sub-field corresponding to the bit digit in the pixel driving data GD which is at logical level 1. Thus, the intermediate luminance level of the display corresponds to a total number of sustain discharges generated throughout the sub-fields SF1-SF(N). In this event, the formation of a wall charge in the pixel cell immediately before the wall charge adjusting stage Ec is as shown in FIG. 7A due to the influence of the selective erasure addressing discharge which was produced in the sub-field indicted by the black circle in FIG. 3. Specifically, a negative charge is formed on the column electrode D; a positive charge on the row electrode X; and a positive charge on the row electrode Y. Here, in the wall charge forming stage E1, as the pulse voltage V₁ of positive polarity is applied to the row electrode Y, and the pulse voltage V₂ of positive polarity to the row electrode X, respectively, a discharge is produced between the row electrode Y and the column electrode D. After the end of the discharge, the formation of charges in the pixel cell transitions to the state as shown in FIG. 7B, where a positive charge is formed on the column electrode D; a positive charge on the row electrode X; and a negative charge on the row electrode Y, respectively. In other words, charges of polarities different from each other remain on the row electrodes X, Y, i.e., a so-called wall charge is formed. Then, in the next wall charge erasing stage E2, as the pulse voltage V₃ of negative polarity is applied to the row electrode Y, and the pulse voltage V₄ of positive polarity to the row electrode X, respectively, a faint erasure discharge is produced between the row electrodes X, Y. After the end of the erasure discharge, the formation of the wall charges in the pixel cell transitions to a state as shown in FIG. 7C, where a positive charge is formed on the column electrode D; a negative charge on the row electrode X; and a negative charge on the row electrode Y, respectively. In other words, a so-called wall charge erased state is present, where the charges of the same polarity (negative polarity) remain on both the row electrodes X, Y, causing the charges to be neutralized.

Therefore, at the time the wall charge adjusting stage Ec is finished, the state in each pixel cell is such that a positive charge is formed on the column electrode D; a negative charge on the row electrode X, and a negative charge on the row electrode Y, as shown in FIGS. 5(c), 6(c), 7(c) when any of the aforementioned (1)-(3) is displayed.

Stated another way, according to the wall charge adjusting stage Ec, the formation of wall charges in all the pixel cells can be uniformly initialized with a faint discharge. It is therefore possible to provide a high-contrast display image, as compared with the case where all the pixel cells are simultaneously rest discharged by force, while preventing an erroneous selective addressing discharge.

In the foregoing embodiment, when an image is displayed at an intermediate luminance level, a discharge is produced between the column electrode D and the row electrode Y through the wall charge adjusting stage Ec, as shown in FIGS. 7A-7C, to form the wall charge. Alternatively, this discharge may be produced between the column electrode D and the row electrode X.

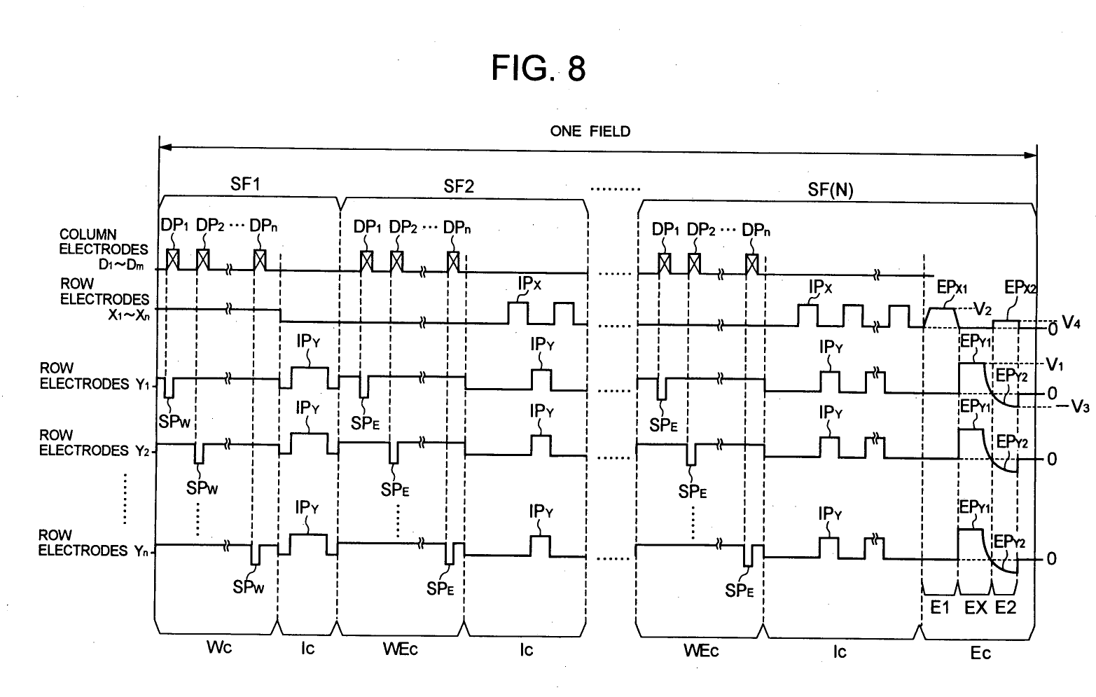

FIG. 8 is a diagram showing timings at which a variety of driving pulses are applied to the column electrodes D₁-Dₘ, row electrodes X₁-Xₙ and Y₁-Yₙ of the PDP 10 by the address data driver 4, first sustain driver 5, and second sustain driver 6, when a discharge is produced between the column electrode D and the row electrode X in the wall charge adjusting stage Ec. In FIG. 8, the operation is the same as that shown in FIG. 4 except that the sustain pulse IPx is applied at the end of each sustain stage Ic, and that the wall charge adjusting stage Ec consists of a wall charge forming stage E1, a wall charge polarity inverting stage EX, and a wall charge erasing stage E2.

In the wall charge forming stage E1 of the wall charge adjusting stage Ec shown in FIG. 8, the first sustain driver 5 simultaneously applies the row electrodes X₁-Xₙ with a wall charge forming pulse EP_{X1}having the pulse voltage V₂ of positive polarity as mentioned above. While the wall charge forming pulse EP_{X1}is applied, the voltage on each of the row electrodes Y₁-Yₙ is maintained at zero volt, as shown in FIG. 8. Next, in the wall charge polarity inverting stage EX, the second sustain driver 6 simultaneously applies the row electrodes Y₁-Yₙ with a wall charge forming pulse EP_{Y1} having the pulse voltage V₁ of positive polarity as mentioned above. While the wall charge forming pulse EP_{Y1} is applied, the voltage on each of the row electrodes X₁-Xₙ is maintained at zero volt as shown in FIG. 8. Next, in the wall charge erasing stage E2, the second sustain driver 6 simultaneously applies the row electrodes Y₁-Yₙ with a wall charge erasing pulse EP_{Y2} having the pulse voltage V₃ of negative polarity which slowly changes in its falling edge, as shown in FIG. 8. Further, in the wall charge erasing stage E3, simultaneously with the timing at which the wall charge erasing pulse E_{Y2} is applied, the sustain driver 5 simultaneously applies the row electrodes X₁-Xₙ with a wall charge erasing pulse EP_{X2} having the pulse voltage V₄ of the positive polarity as shown in FIG. 8. The pulse voltage V₄ of the wall charge erasing pulse EP_{X2} is lower than the pulse voltage V₂ of the wall charge forming pulse EP_{X1}.

The following description will be made on the operation in the wall charge adjusting stage Ec shown in FIG. 8 separately for a display performed corresponding to the minimum luminance level, a display performed corresponding to the maximum luminance level, and a display performed corresponding to an intermediate luminance level.

(1) Display Performed Corresponding to Minimum Luminance Level (Black Display)

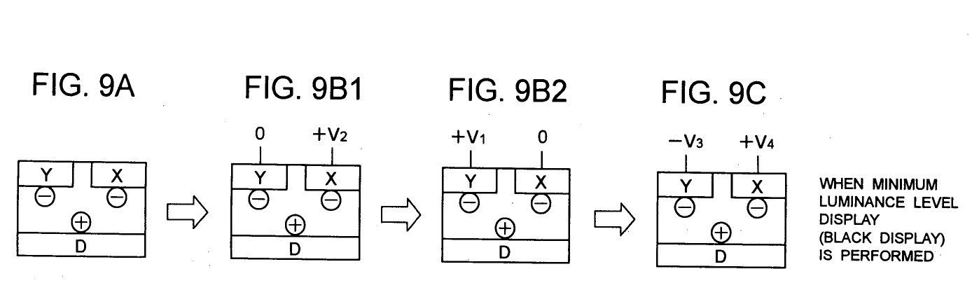

In this event, since the driving is performed corresponding to a first gradation level shown in FIG. 1, the formation of a wall charge in the pixel cell immediately before the wall charge adjusting stage Ec is as shown in FIG. 9A because any discharge has not been so far produced before. Specifically, a positive charge is formed on the column electrode D; a negative charge on the row electrode X; and a negative charge on the row electrode Y. Here, while the pulse voltage V₂ of positive polarity is applied to the row electrode X in the wall charge forming stage E1, any of the voltage between the row electrodes X, Y, the voltage between the row electrode X and the column electrode D, and the voltage between the row electrode Y and the column electrode D does not reach the discharge start voltage, so that no discharge is produced. Therefore, as shown in FIG. 9B1, the formation of the wall charge in each pixel cell upon execution of the wall charge forming stage E1 remains unchanged from the state as shown in FIG. 9A. Next, while the pulse voltage V₁ of positive polarity is applied to the row electrode Y in the wall charge polarity inverting stage EX, any of the voltage between the row electrodes Y, Y, the voltage between the row electrode X and the column electrode D, and the voltage between the row electrode Y and the column electrode D does not reach the discharge start voltage, so that no discharge is produced. Therefore, as shown in FIG. 9B2, the formation of the wall charge in each pixel cell upon execution of the wall charge polarity inverting stage EX remains unchanged from the state as shown in FIGS. 9(a) and 9(b1). Then, in the next wall charge erasing stage E2, the pulse voltage V₃ of negative polarity is applied to the row electrode Y, and the pulse voltage V₄ of positive polarity is applied to the row electrode X, respectively, but even at this time, any of the voltage between the row electrodes X, Y, the voltage between the row electrode X and the column electrode D and the voltage between the row electrode Y and the column electrode D does not reach the discharge start voltage, so that no discharge is produced. Therefore, as shown in FIG. 9C, the formation of the wall charge in each pixel cell upon execution of the wall charge erasing stage E2 remains unchanged from the state as shown in FIGS. 9(a), 9(b1), 9(b2).

(2) Display Performed Corresponding to Maximum Luminance Level

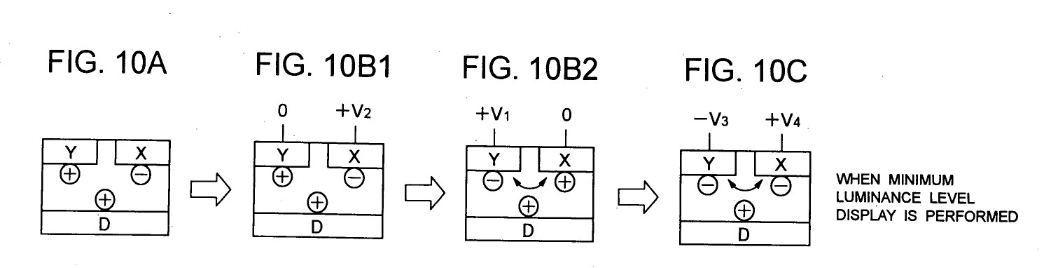

In this event, the driving is performed corresponding to an (N+1)th gradation level shown in FIG. 3. Therefore, the formation of a wall charge in the pixel cell immediately before the wall charge adjusting stage Ec is in a state as shown in FIG. 10A by the influence of a sustain discharge which is produced in response to the last sustain pulse IP_{X} in the sustain stage Ic of the sub-field SF(N). Specifically, a positive charge is formed on the column electrode D; a negative charge on the row electrode X; and a positive charge on the row electrode Y. Here, while the pulse voltage V₂ of positive polarity is applied to the row electrode X in the wall charge forming stage E1, any of the voltage between the row electrodes X, Y, the voltage between the row electrode X and the column electrode D, and the voltage between the row electrode Y and the column electrode D does not reach the discharge start voltage, so that no discharge is produced. Therefore, as shown in FIG. 10B1, the formation of the wall charge in each pixel cell upon execution of the wall charge forming stage E1 remains unchanged from the state as shown in FIG. 10A. Next, as the pulse voltage V₁ of positive polarity is applied to the row electrode Y in the wall charge polarity inverting stage EX, a negative charge is formed on the row electrode X, and a positive charge is formed on the row electrode Y, causing a discharge to be produced between the row electrodes Y, Y. After the end of the discharge, the formation of the wall charge in the pixel cell is as shown in FIG. 10B2, where a positive charge is formed on the column electrode D; a positive charge on the row electrode X; and a negative charge on the row electrode Y. In other words, the charges of polarities different from each other remain on the row electrodes X, Y, resulting in the formation of the so-called wall charge. Then, in the wall charge erasing stage E2, as the pulse voltage V₃ of negative polarity is applied to the row electrode Y, and the pulse voltage V₄ of positive polarity is applied to the row electrode X, respectively, a faint erasure discharge is produced between the row electrodes Y, Y due to the positive charge formed on the row electrode X and the negative charge formed on the row electrode Y, respectively. After the end of the erasure discharge, a negative charge is formed on the row electrode X, and a negative charge is formed on the row electrode Y. In other words, a so-called charge extinction state is present, where charges of the same polarity (negative polarity) remain on both the row electrodes X, Y to neutralize the charges.

(3) Display Performed Corresponding to Intermediate Luminance Level

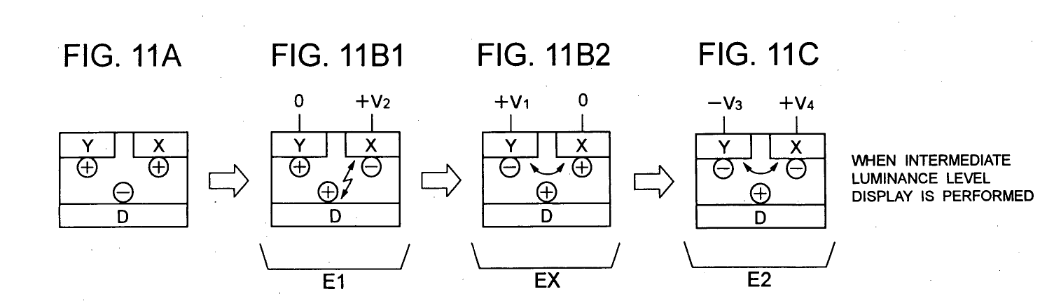

In this event, the formation of a wall charge in the pixel cell immediately before the wall charge adjusting stage Ec is in a form as shown in FIG. 11(a) due to the influence of the selective erasure addressing discharge which was produced in a sub-field indicated by a black circle in FIG. 3. Specifically, a negative charge is formed on the column electrode D; a positive charge on the row electrode X; and a positive charge on the row electrode Y. Here, as the pulse voltage V₂ of positive polarity is applied to the row electrode X in the wall charge forming stage E1, a discharge is produced between the row electrode X and the column electrode D because the negative charge has been formed on the column electrode, and the positive charge has been formed on the row electrode X. After the end of the discharge, the formation of the wall charge in the pixel cell is as shown in FIG. 11(b1), where a positive charge is formed on the column electrode D; a negative charge on the row electrode X; and a positive charge on the row electrode Y. In other words, the so-called wall charge has been formed, where charges of different polarities from each other remain on the row electrodes X, Y. Next, as the pulse voltage V₁ of positive polarity is applied to the row electrode Y in the wall charge polarity inverting stage EX, a discharge is produced between the row electrodes X, Y since the negative charge has been formed on the row electrode X, and the positive charge has been formed on the row electrode Y. After the end of the discharge, the formation of wall charge within the pixel cell is as shown in FIG. 11(b2), where a positive charge is formed on the column electrode D; a positive charge on the row electrode X; and a negative charge on the row electrode Y. In mother words, the so-called wall charge has been formed, where charges of different polarities from each other remain on the row electrodes X, Y. Then, in the wall charge erasing stage E2, as the pulse voltage V₃ of negative polarity is applied to the row electrode Y, and the pulse voltage V₃ of negative polarity is applied to the row electrode X, a faint erasure discharge is produced between the row electrodes X, Y since the positive charge has been formed on the row electrode X, and the negative charge has been formed on the row electrode Y. After the end of the erasure discharge, the formation of the wall charge in the pixel cell is as shown in FIG. 11(c), where a positive charge is formed on the column electrode D; a negative charge on the row electrode X; and a negative charge on the row electrode Y, respectively. In other words, a so-called charge extinction state is present, where charges of the same polarity (negative polarity) remain on both the row electrodes X, Y to neutralize the charges.

Therefore, the state in each pixel cell at the end of the wall charge adjusting stage Ec is the same as that shown in FIGS. 9(c), 10(c), and 11(c) when any of the aforementioned (1)-(3) is displayed.

Thus, the driving sequence as shown in FIG. 8 can also uniformly initialize the formation of the wall charge in all the pixel cells with a faint discharge, thus making it possible to provide a higher contrast display image, as compared with the case where all the pixel cells are simultaneously reset discharged by force.

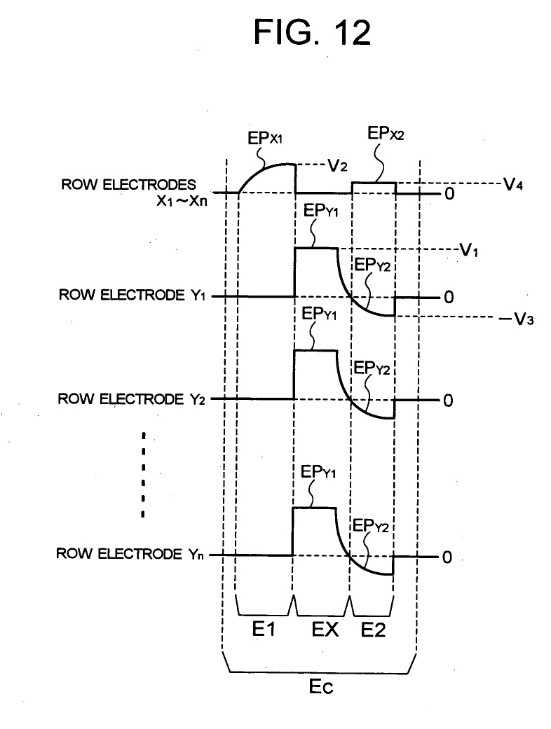

In conducting the driving sequence shown in FIG. 8, a change in voltage in a rising edge of the wall charge forming pulse EP_{X1}applied to the row electrode X in the wall charge forming stage E1 may be made slow, as shown in FIG. 12. In this way, a weaker discharge is produced between the row electrodes X and the column electrode D, so that images can be displayed at a higher contrast.

While the foregoing embodiment has shown a driving sequence which omits an initializing operation for forcing all the pixel cells to simultaneously produce a reset discharge, this reset discharge may be produced only upon power-on or one per a plurality of fields.

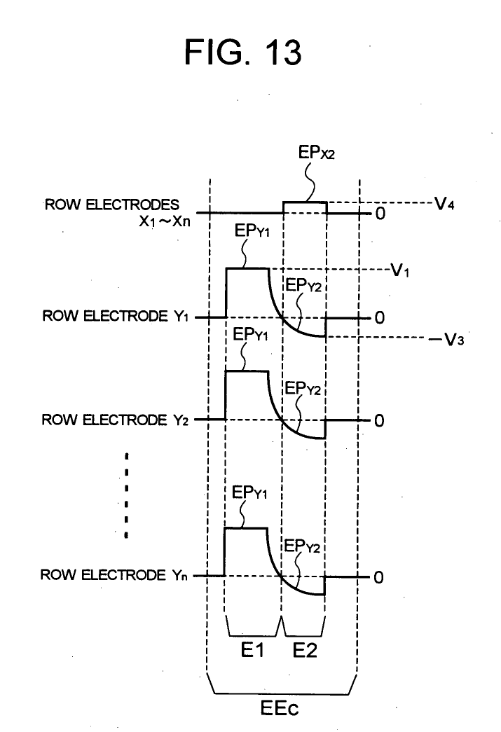

When such a driving sequence is applied, for example, to the driving sequence shown in FIG. 4, the wall charge adjusting stage Ec performed in the last sub-field SF(N) is replaced with a wall charge adjusting stage EEc as shown in FIG. 13 only when the power is turned on. Alternatively, the wall charge adjusting stage EEc as shown in FIG. 13 is executed instead of the wall charge adjusting stage Ec once per M fields (M is an integer equal to or larger than two),

In the wall charge adjusting stage EEc shown in FIG. 13, first, the second sustain driver 6 simultaneously applies the row electrodes Y₁-Yₙ with a wall charge forming pulse EP_{Y1} having the pulse voltage V₁ of positive polarity in the wall charge forming stage E1. While the wall charge forming pulse EP_{Y1} is applied, the voltage on each of the row electrodes X₁-Xₙ is maintained at zero volt, as shown in FIG. 13. In the wall charge erasing stage E2, similar to FIG. 4, a wall charge erasing pulse EP_{Y2} having the pulse voltage V₃ of negative polarity is applied to the row electrodes Y₁-Yₙ, and at the same timing at which the wall charge erasing pulse EP_{Y2} is applied, a wall charge erasing pulse EP_{X2} having a pulse voltage V₄ of positive polarity is simultaneously applied to the row electrodes X₁-Xₙ. In this event, since the row electrode X is not applied with the wall charge forming pulse EP_{X1} of positive polarity in the wall charge forming stage E1 of the wall charge adjusting stage EEc shown in FIG. 13, the voltage between the row electrodes X, Y in all the pixel cells exceeds the discharge start voltage. This causes simultaneous reset discharges in all the pixel cells.

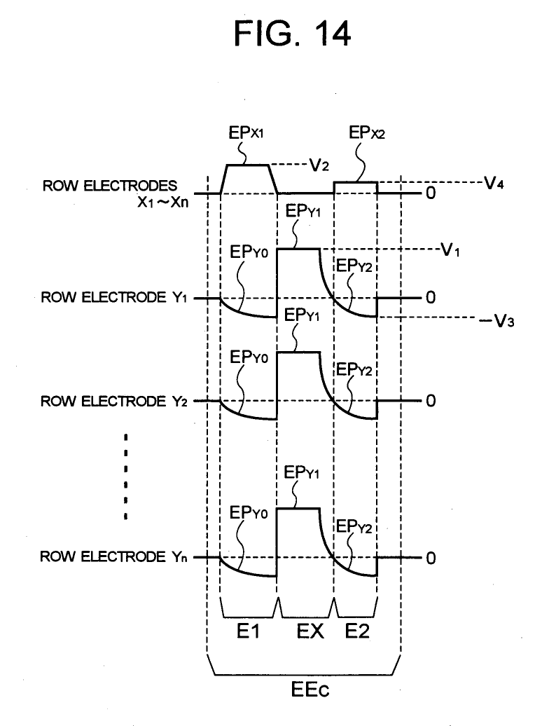

On the other hand, when the reset discharge operation as described above is applied to the driving sequence as shown in FIG. 8, the wall charge adjusting stage Ec performed in the last sub-field SF(N) is replaced with a wall charge adjusting stage EEc as shown in FIG. 14 only when the power is turned on. Alternatively, the wall charge adjusting stage EEc shown in FIG. 14 is executed instead of the wall charge adjusting stage Ec once per M fields (M is an integer equal to or larger than two).

In the wall charge forming stage E1 in the wall charge adjusting stage EEc shown in FIG. 14, at the same time the wall charge forming pulse EP_{X1}as mentioned above is applied to the row electrodes X₁-Xₙ, the row electrodes Y₁-Yₙ are simultaneously applied with a wall charge forming pulse EP_{Y0} of negative polarity, the voltage of which changes slowly in a falling edge. In the next wall charge polarity inverting stage EX, similar to FIG. 8, the wall charge forming pulse EP_{Y1} of positive polarity is simultaneously applied with the row electrodes Y₁-Yₙ, and in the meantime, the voltage at each of the row electrodes X₁-Xₙ is maintained at zero volt. Then, in the wall charge erasing stage E2, similar to FIG. 8, the wall charge erasing pulse EP_{Y2} of negative polarity is applied to the row electrodes Y₁-Yₙ, and the wall charge erasing pulse EP_{X2} of positive polarity is applied to the row electrodes X₁-Xₙ. In this event, in the wall charge forming stage E1 of the wall charge adjusting stage EEc shown in FIG. 14, while the row electrode X is applied with the wall charge forming pulse EP_{X1}of positive polarity, the row electrode Y is applied with the wall charge forming pulse EP_{Y0} of negative polarity, so that the voltage between the row electrodes X, Y in all the pixel cells exceeds the discharge start voltage. This causes reset discharges to be simultaneously produced in all the pixel cells.

This application is based on Japanese Patent Application No. 2004-83108 which is hereby incorporated by reference.

1. A method of driving a display panel formed with pixel cells associated with pixels at intersections of a plurality of row electrode pairs corresponding to display lines with a plurality of column electrodes arranged across said row electrode pairs for driving said display panel every plural sub-fields which make up each field of an input video signal, wherein:
a first sub-field in each field includes a selective write addressing stage for performing selective write addressing for selectively forming a wall charge in each of said pixel cells in accordance with the input video signal, and a sustain stage for sustaining light emitted in only those pixel cells formed with the wall charge out of said pixel cells;
each of sub-fields subsequent to the first sub-field in each field includes a selective erasure addressing stage for performing selective erasure addressing for selectively erasing the wall charge formed in each of said pixel cells in accordance with the input video signal, and a sustain stage for maintaining light emitted in only pixels formed with the wall charges out of said pixel cells; and
a last sub-field in each field includes a wall charge forming stage for forming a wall charge by inverting the polarity of a charge formed near each of one of said row electrode pairs and said column electrodes in each of said pixel cells which have undergone the selective write addressing and the selective erasure addressing in the field, and a wall charge erasing stage for erasing the wall charge by inverting the polarity of a charge formed near the other row electrode of said row electrode pair in each of said pixel cells which have under gone the selective write addressing in said field.

2. A method of driving a display panel according to claim 1, wherein said wall charge forming stage simultaneously produces a discharge between the row electrodes of said electrode pair in each of said all said pixel cells only once per a plurality of fields to form wall charges in all said pixel cells.

3. A method of driving a display panel formed with pixel cells associated with pixels at intersections of a plurality of row electrode pairs corresponding to display lines with a plurality of column electrodes arranged across said row electrode pairs for driving said display panel every plural sub-fields which make up each field of an input video signal, wherein:
a first sub-field in each field includes a selective write addressing stage for performing a selective write addressing for selectively forming a wall charge in each of said pixel cells in accordance with the input video signal, and a sustain stage for sustaining light emitted in those pixel cells formed with the wall charge out of said pixel cells;
each of sub-fields subsequent to the first sub-field in each field includes a selective erasure addressing stage for performing selective erasure addressing for selectively erasing the wall charge formed in each of said pixel cells in accordance with the input video signal, and a sustain stage for maintaining light emitted in only pixels formed with the wall charges out of said pixel cells; and
a last sub-field in each field includes a wall charge forming stage for forming a wall charge by inverting the polarity of a charge formed near each of one of said row electrode pairs and said column electrode in each of said pixel cells which have undergone the selective write addressing and the selective erasure addressing in the field, a wall charge polarity inverting stage for inverting the polarity of a charge formed near each of the row electrodes of said row electrode pair in said pixel cells which have undergone the selective write addressing in the field, and a wall charge erasing stage for erasing the wall charge by inverting the polarity of a charge formed near the other row electrode of said row electrode pair in each of said pixel cells which have under gone the selective write addressing in the field.

4. A method of driving a display panel according to claim 3, wherein said wall charge forming stage simultaneously produces a discharge between the row electrodes of said electrode pair in each of said all said pixel cells only once per a plurality of fields to form wall charges in all said pixel cells.

5. A method of driving a display panel according to claim 3, wherein said wall charge forming stage inverts the polarity of the charge and forms the wall charge by applying a driving voltage which slowly changes across the row electrodes of said row electrode pair in each of all said pixel cells.
